(19) United States
(12) Patent Application Publication
(10) Pub. No.: US 2021/0219016 A1
(43) Pub. Date: Jul. 15, 2021

(54) FIBER OPTIC BASED HDMI CABLE ADDED WITH INTEGRATED IR INFRARED REMOTE CONTROL WITHOUT REDUCING HDMI CONNECTIONS AND STANDARD SPECS

(71) Applicants: Luca Zanetti, Orlando, FL (US); Silvia Fioravanti, Orlando, FL (US)

(72) Inventors: Luca Zanetti, Orlando, FL (US); Silvia Fioravanti, Orlando, FL (US)

(21) Appl. No.: 16/743,497

(22) Filed: Jan. 15, 2020

(51) Int. Cl. H04N 21/4363; G02B 6/42

(52) U.S. Cl. CPC H04N 21/43635; G02B 6/4249; G02B 6/4284

(57) ABSTRACT

A Fiber optic based hdmi cable also called in some cases aoc active optical cable, ADDED WITH INTEGRATED IR INFRARED REMOTE CONTROL capabilities to remote control uni-directional and bi-directional audio video and it devices remotely from each-other sides of the hdmi fiber optic based cable, integrated within same the hdmi fiber-based cable, without requiring additional cables and devices, without disrupting or reducing the hdmi standard & connections full specs. IR INFRARED transmitter and receiver eyes from the hdmi fiber optic based cable can be either or both integrated in the/on to the hdmi fiber connector housing shell, keystone, wallplate, multimedia strip, and any other fixed or flying shape of housing, or externally connected via additional IR EYES connectors added on the hdmi aoc fiber connector housing shell, or extrapolated from the hdmi fiber optic based cable using any flying wiring and any connection solution

### BACKGROUND OF THE INVENTION

This invention relates to adding the IR INFRARED REMOTE CONTROL mechanism to the HDMI FIBER-BASED CABLES technology and production also called in some cases AOC active optical cables, to be able to remote control in an integrated within-the-same-cable way hdmi av devices and ir devices from each-other sides of the hdmi fiber-based cable, without reducing the hdmi full standard specs connections and functionalities

### SUMMARY OF THE INVENTION

The present invention is directed to integrating an IR INFRARED REMOTE CONTROL mechanism within the HDMI FIBER-BASED Cables technology also in some cases called HDMI AOC active optical cable, in order to facilitate the remote control of IR devices such as tvs, media players, set top boxes, disk players, av receivers, Bluetooth devices, home automation devices and systems, and any other ir remote controllable device, from each-other sides of the hdmi fiber-based cable within the same fiber-based cable, without requiring additional cables and installation, without reducing the hdmi full standard connections and functionalities specs.

An object of the present invention is to simplify the audio video multimedia over fiber-based aoc cables installation by integrating the IR remote control mechanism within the same HDMI Fiber-based cable eliminating the need of additional external converters with their eventual power supply and additional wires and reducing the system installation time and electrical power consumption, increasing the overall reliability and the environmental health.

Another object of the present invention is to be able to use the benefits of the hdmi fiber-based aoc cables technology which offers zero-delay full bandwidth audio video up to 4 k 8 k 10 k and higher uncompressed unprocessed 4:4:4 full quality and higher resolutions, AND ADD TO IT THE ABILITY TO CONTROL IR INFRARED REMOTE DEVICES such as set top boxes, av receivers, media centers, media players, matrixes, ip players, home automation, and any ir controllable device, typically wanted/installed in another room, closet, basement, in order to keep the audio video multimedia automation installation simple and clean with only the television set in the rooms, and all the av components away, without disrupting nor reducing the full hdmi standard connection & specs features, IR REMOTE CONTROL OTHERWISE IMPOSSIBLE to do with the regular hdmi fiber-based cables so usually only achievable by adding more external components and/or additional/special shared or dedicated cables and extenders of any type.

To achieve these goals an IR infrared electric block is added and integrated to each of hdmi fiber-based cable sides.

The IR INFRARED BLOCKS can receive and transmit each-other the IR INFRARED COMMANDS captured and emitted in the rooms via IR EYES transmitters and receivers sensors connected to the IR INFRARED blocks. The IR EYES can receive or transmit or receive and transmit IR COMMANDS from IR remote controls such as tv remote controls, home automation controls, control tablets and phones, programmable ir remote controls—to Audio Video TV systems and any IR controllable devices. The IR EYES can be integrated directly on the hdmi fiber-based cable connectors housing shells and/or IR INFRARED BLOCKS housing shells of the fiber-based hdmi cable

The IR EYES can also be separated parts with a wire connected to the main hdmi fiber-based cable via pluggable connectors such as 3.5 mm jacks or any other, where these pluggable IR ports can be installed and integrated directly inside the hdmi fiber-based cable connector housing shell, or flying floating connectors from the cable. The IR EYES might also be already connected/wired to each side of the main hdmi fiber-based cable

The typical installation of the IR-EYE Receiver is via adhesive in front of the viewing TV, so the IR EYE can “see and capture” ir commands coming from the room remote control/s and send them to the other side of the HDMI fiber-optic-based AOC cable reproducing them through the IR-EYE TRANSMITTER in front of the remote controllable destination device/s, controlling it. Some TV sets also provide a plug-in jack on the rear TV connections, to use the TV IR EYE built-in into the TV in place of installing another adhesive ir eye in front of the TV, usually on the TV bezel. In this case the TV IR EYE jack can be connected directly to the IR INFRARED BLOCK so the ir commands will be captured and delivered to the other side of the HDMI fiber-based cable directly from the IR EYE built-into the TV.

The Copper and/or fiber optic IR INFRARED with HDMI cable, connectors and mechanism here described can also be added with additional data connections and connectors such as ethernet, serial, audio, video, data, toslink, spdif, sdi video, multiple sdi video up to 8 k and higher, aes ebu, composite video, component video, and any other audio video data connection, to create a IR INFRARED CABLE and mechanism with multiple multi-standard connections and combination, so the IR INFRARED mechanism will be able no only to remote control remote HDMI devices from each-other sides of the IR HDMI copper and/or optical CABLE, but as well other different non HDMI devices, while the IR INTEGRATED MULTI-STANDARD CABLE will offer multiple types of connection at once with the IR control feature. By replacing the IR SENSORS with different source and destination devices, the invention allows the connection between any serial data communication devices within the same HDMI cable, without disrupting, using or reducing the HDMI connection full standard and functionality (any type), without requiring additional external adapters converters, repeaters or external additional cables.

### BRIEF DESCRIPTION OF THE DRAWINGS

FIG. 1 schematically illustrates the operation of the IR INFRARED mechanism added to the AOC HDMI fiber optic-based cables

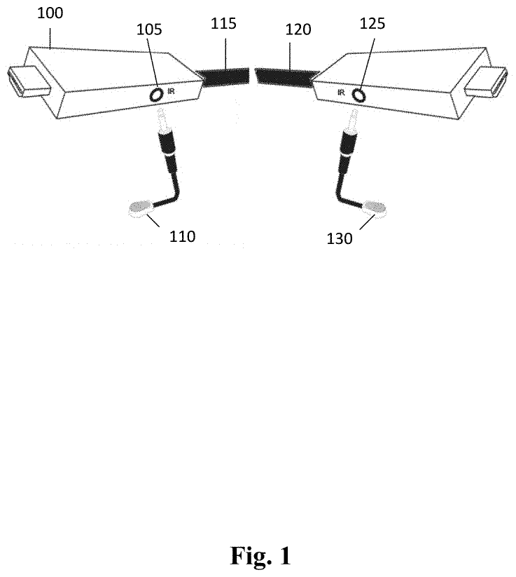

FIG. 2 schematically illustrates an example of IR EYES connection connectors installed on the HDMI fiber-based cable housing shell.

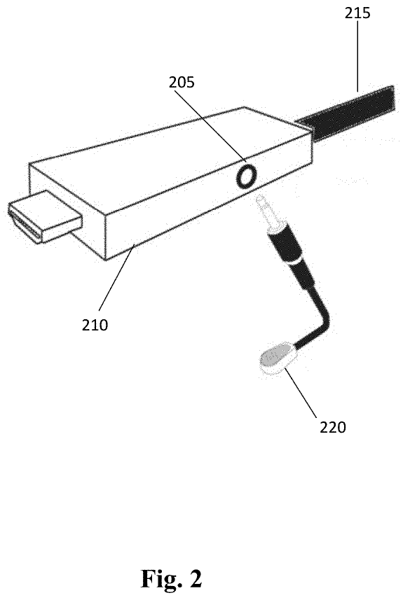

FIG. 3 schematically illustrates an example of IR EYES connection connectors flying/floating from the HDMI fiber-based cable housing shell.

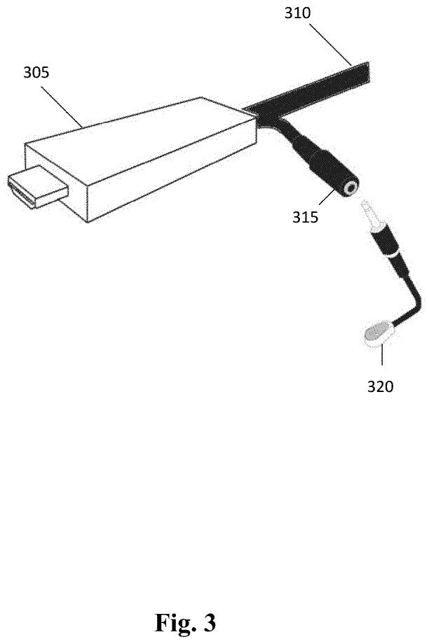

FIG. 4 schematically illustrates an example of IR EYES connection connectors flying/floating from the HDMI fiber-based cable.

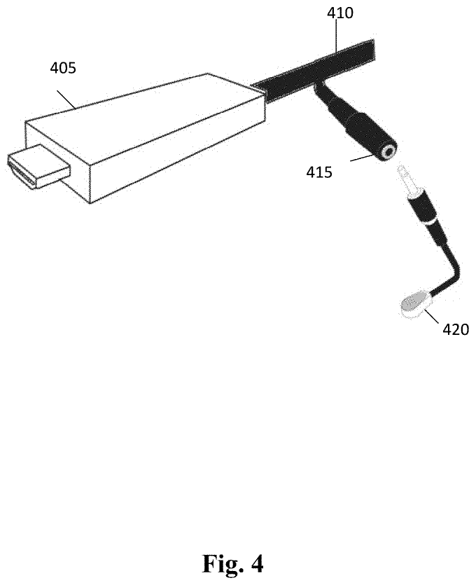

FIG. 5 illustrates application examples, according to an embodiment of the present invention.

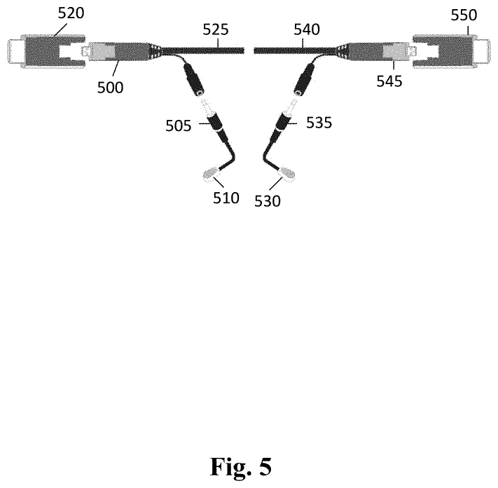

FIG. 6 illustrates application examples, according to an embodiment of the present invention.

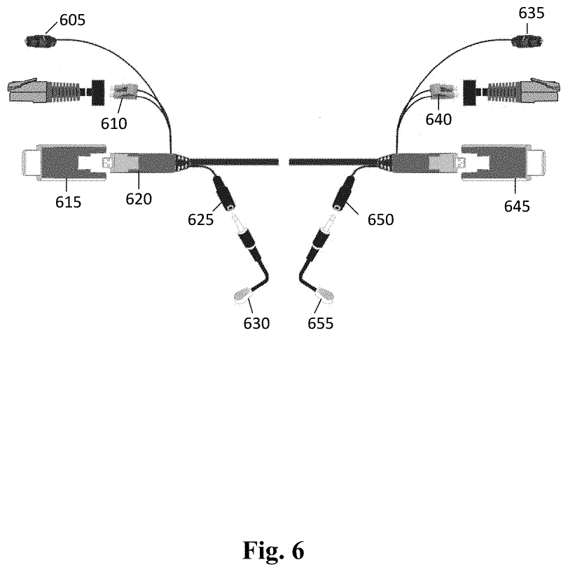

FIG. 7 illustrates application examples, according to an embodiment of the present invention.

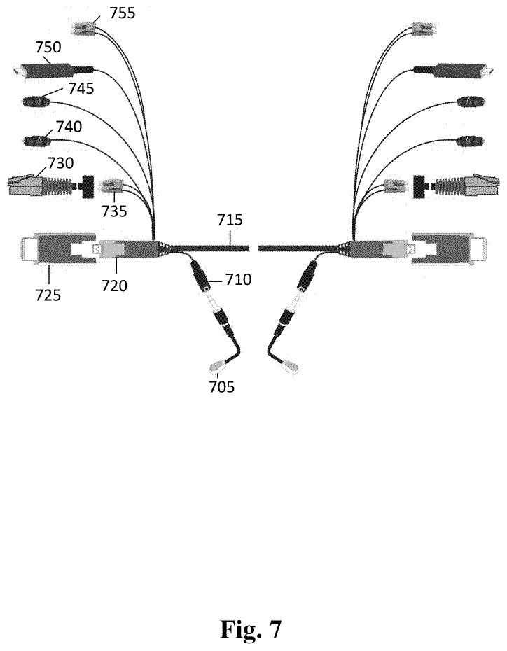

### DETAILED DESCRIPTION

### Reference Numerals

100: HDMI fiber optic based connector
105: IR Connector
110: IR Eye
115: Fiber optic based cable
120: Fiber optic based cable
125: IR Connector
130: IR Eye
205: IR Connector
210: HDMI fiber optic based connector
215: Fiber optic based cable
220: IR Eye
305: HDMI fiber optic based connector
310: Fiber optic based cable
315: IR Connector
320: IR Eye
405: HDMI fiber optic based connector
410: Fiber optic based cable
415: IR Connector
420: IR Eye
500: Mini micro HDMI
505: IR Connector
510: IR Eye
520: Full size HDMI adaptor
525: Fiber optic based cable
530: IR Eye
535: IR Connector
540: Fiber optic based cable
545: Mini micro HDMI
550: Full size HDMI adaptor
605: TOSLINK uncompressed digital audio
610: LC Ethernet
615: Full size HDMI adaptor
620: Mini micro HDMI
625: IR Connector
630: IR Eye
635: TOSLINK uncompressed digital audio
640: LC Ethernet
645: Full size HDMI adaptor
650: IR Connector
655: IR Eye
705: IR Eye
710: IR Connector
715: Fiber optic based cable
720: Mini micro HDMI
725: Full size HDMI adaptor
730: LC to RJ45 cable converter
735: LC Ethernet
740: TOSLINK uncompressed digital audio
745: TOSLINK uncompressed digital audio
750: USB Port
755: Auxiliary dual fiber LC

What is claimed is:

1. A Fiber optic based uncompressed zero-delay full quality hdmi cable also called in some cases aoc active optical cable, ADDED WITH INTEGRATED IR INFRARED REMOTE CONTROL capabilities to remote control uni-directional and bi-directional audio video and ir devices remotely from each-other sides of the hdmi fiber optic cable, integrated with the same hdmi fiber-based cable, without requiring additional cables and devices, without disrupting or reducing the hdmi standard & connections full specs such as cec arc earc etc which remains fully functional.

2. The fiber optic based hdmi connector is added with an IR INFRARED REMOTE CONTROL block where the transmitter/receiver IR INFRARED EYES can be either or both integrated in the/on to the hdmi fiber connector housing shell or externally connected via additional IR EYES connectors added on the hdmi aoc fiber connector housing shell, or extrapolated from the hdmi fiber optic based cable using any flying wiring and any connection solution.
